(19) United States
(12) Patent Application Publication
(10) Pub. No.: US 2026/0204813 A1
(43) Pub. Date: Jul. 16, 2026

(54) TERMINATED WIRE AND A METHOD FOR MANUFACTURING THE SAME

(71) Applicant: SUMITOMO WIRING SYSTEMS, LTD., Yokkaichi-shi (JP)

(72) Inventor: Hiroki YAMANOUCHI, Yokkaichi-shi (JP)

(73) Assignee: SUMITOMO WIRING SYSTEMS, LTD., Yokkaichi-shi (JP)

(21) Appl. No.: 19/442,542

(22) Filed: Jan. 7, 2026

(30) Foreign Application Priority Data
Jan. 10, 2025 (JP) 2025-004089

(51) Int. Cl. H01R 4/72

(52) U.S. Cl. CPC H01R 4/72

(57) ABSTRACT

A terminated wire including: a core wire; an insulating coating that covers the core wire; a terminal that is connected to the core wire exposed from the insulating coating; and a shrinkable tube that covers a portion of the core wire and a portion of the terminal and that has an adhesive disposed on an inner surface of the shrinkable tube.

### BACKGROUND

The present disclosure relates to a terminated wire and a method for manufacturing the same.

Some conventional terminated wires include an electric wire, a terminal, and a shrinkable tube (e.g., see JP 2023-178648A). The electric wire includes a core wire and an insulating coating that covers the core wire. The terminal is connected to the core wire exposed from the insulating coating. More specifically, the terminal has a plate shape having first and second main surfaces. The terminal has a core wire connection section to which the core wire disposed on the first main surface is connected, a counterpart connection section that is to be connected to a counterpart member, and a terminal intermediate section that connects the core wire connection section and the counterpart connection section. The shrinkable tube has an adhesive disposed on its inner surface, and covers a portion of the electric wire and a portion of the terminal. The shrinkable tube extends over the core wire connection section, the core wire, and the terminal intermediate section. This prevents the portion at which the terminal and the core wire are connected from being exposed to water.

### SUMMARY

In a terminated wire such as that described above, the adhesive disposed on the inner surface of the shrinkable tube tends to accumulate locally in larger amounts at a stepped portion formed when the core wire is placed on the first main surface. Accordingly, the water sealing performance along the first main surface tends to be lower than the water sealing performance along the second main surface.

An exemplary aspect of the disclosure provides a terminated wire and a method for manufacturing a terminated wire that can enhance water sealing performance.

A terminated wire according to the present disclosure is a terminated wire including: an electric wire having a core wire and an insulating coating covering the core wire; a terminal connected to the core wire exposed from the insulating coating; and a shrinkable tube covering a portion of the electric wire and a portion of the terminal and having an adhesive disposed on an inner surface of the shrinkable tube, wherein the terminal is formed in a plate shape having a first main surface and a second main surface, and the terminal has: a core wire connection section to which the core wire disposed on the first main surface is connected; a counterpart connection section that is to be connected to a counterpart member; and a terminal intermediate section connecting the core wire connection section and the counterpart connection section, and the shrinkable tube extends over the core wire connection section, the core wire, and the terminal intermediate section, and covers the first main surface of the terminal intermediate section over a longer length than the second main surface of the terminal intermediate section.

The terminated wire and the method for manufacturing a terminated wire according to the present disclosure can enhance water sealing performance.

### BRIEF DESCRIPTION OF THE DRAWINGS

FIG. 1 is a partial cross-sectional view of a terminated wire in the process of being manufactured according to one embodiment;

FIG. 2 is a plan view of the terminated wire in the process of being manufactured according to one embodiment; and

FIG. 3 is a partial cross-sectional view of the terminated wire according to one embodiment.

### DETAILED DESCRIPTION OF EMBODIEMENTS

### Description of Embodiments of the Present Disclosure

First, modes for implementing the present disclosure are listed and described.

A terminated wire according to the present disclosure is:

[1] a terminated wire including: an electric wire having a core wire and an insulating coating covering the core wire; a terminal connected to the core wire exposed from the insulating coating; and a shrinkable tube covering a portion of the electric wire and a portion of the terminal and having an adhesive disposed on an inner surface of the shrinkable tube, wherein the terminal is formed in a plate shape having a first main surface and a second main surface, and the terminal has: a core wire connection section to which the core wire disposed on the first main surface is connected; a counterpart connection section that is to be connected to a counterpart member; and a terminal intermediate section connecting the core wire connection section and the counterpart connection section, and the shrinkable tube extends over the core wire connection section, the core wire, and the terminal intermediate section, and covers the first main surface of the terminal intermediate section over a longer length than the second main surface of the terminal intermediate section.

With this configuration, the shrinkable tube extends over the core wire connection section, the core wire, and the terminal intermediate section, and covers the first main surface of the terminal intermediate section over a longer length than the second main surface of the terminal intermediate section. This can enhance water sealing performance along the first main surface. Specifically, the first main surface, on which the core wire is disposed, tends to have lower water sealing performance than the second main surface, due in part to the formation of a step on the first main surface that causes the adhesive to accumulate locally in larger amounts. The first main surface, which thus tends to have lower water sealing performance, is covered by the shrinkable tube over a longer length than the second main surface, and a larger amount of adhesive is disposed for the longer covered portion. The water sealing performance can thereby be enhanced. Accordingly, the water sealing performance along both the first and second main surfaces can be enhanced sufficiently.

[2] In [1] above, the terminal intermediate section may have a bent portion that is bent such that the first main surface faces outward, and the shrinkable tube may cover the first main surface at the bent portion.

With this configuration, the terminal intermediate section has a bent portion that is bent such that the first main surface faces outward, and the shrinkable tube covers the first main surface at the bent portion. This can particularly enhance the water sealing performance of the first main surface whose water sealing performance tends to be low.

[3] In [1] or [2] above, the terminal intermediate section may have, in an area thereof exposed from the shrinkable tube, a suppression portion configured to suppress a flow of the adhesive toward the counterpart connection section along the first main surface.

With this configuration, the terminal intermediate section has a suppression portion that suppresses the flow of the adhesive toward the counterpart connection section along the first main surface, in the area exposed from the shrinkable tube. The adhesive is thereby prevented from reaching the counterpart connection section. The first main surface is also provided with a greater amount of adhesive due to the first main surface being covered by the shrinkable tube for the longer length than the second main surface. Thus, a large amount of melted adhesive may flow toward the counterpart connection section, but this adhesive is prevented from reaching the counterpart connection section.

[4] In [3] above, the suppression portion may be a protrusion projecting from the first main surface.

With this configuration, the suppression portion is a protrusion projecting from the first main surface, and accordingly, can be readily provided on a plate-shaped terminal.

A method for manufacturing a terminated wire according to the present disclosure is a method for manufacturing the terminated wire according to any one of [1] to [4] above, including: a disposing step of disposing the shrinkable tube before being shrunk on an outer side of the terminal, the shrinkable tube having the adhesive disposed on the inner surface thereof and having an obliquely cut first end, such that a longer portion of the first end faces the first main surface; and a shrinking step of shrinking the shrinkable tube after the disposing step.

With this configuration, the shrinkable tube can be provided so as to cover the first main surface of the terminal intermediate section over a longer length than the second main surface of the terminal intermediate section, using a simple method. Accordingly, the water sealing performance along both the first and second main surfaces can easily be enhanced sufficiently.

### Details of Embodiments of the Present Disclosure

Specific examples of a terminated wire according to the present disclosure will be described below with reference to the drawings. In the drawings, some configurations may be exaggerated or simplified for convenience of description. Also, the dimensional proportions between parts may differ between the drawings.

The term “tubular shape” as used herein may include not only a shape in which peripheral walls are formed continuously over an entire circumference in a circumferential direction, but also a tubular shape formed by combining multiple parts, and a shape having a cutout or the like in a portion in the circumferential direction, such as a C-shape. The outer shape of the “tubular shape” may include, but is not limited to, a circular shape, an elliptical shape, and a polygonal shape with pointed or round corners. The “tubular shape” may be a shape having a through-hole in a plan view, and may include a shape in which the outer shape is the same as the inner shape around the through-hole, and a shape in which the outer shape differs from the inner shape around the through-hole. The “tubular shape” may include a shape having a predetermined length along an axial direction in which its center axis passing through the center of the through-hole extends, regardless of the length. The term “facing” as used herein refers to faces or members being opposite each other, and includes not only cases in which they are entirely opposite each other, but also cases in which they are partially opposite each other.

It should be noted that the present disclosure is not limited to these examples but is defined by the claims, and all modifications equivalent in meaning and scope to the claims are intended to be embraced therein.

### Configuration of Terminated Wire 10

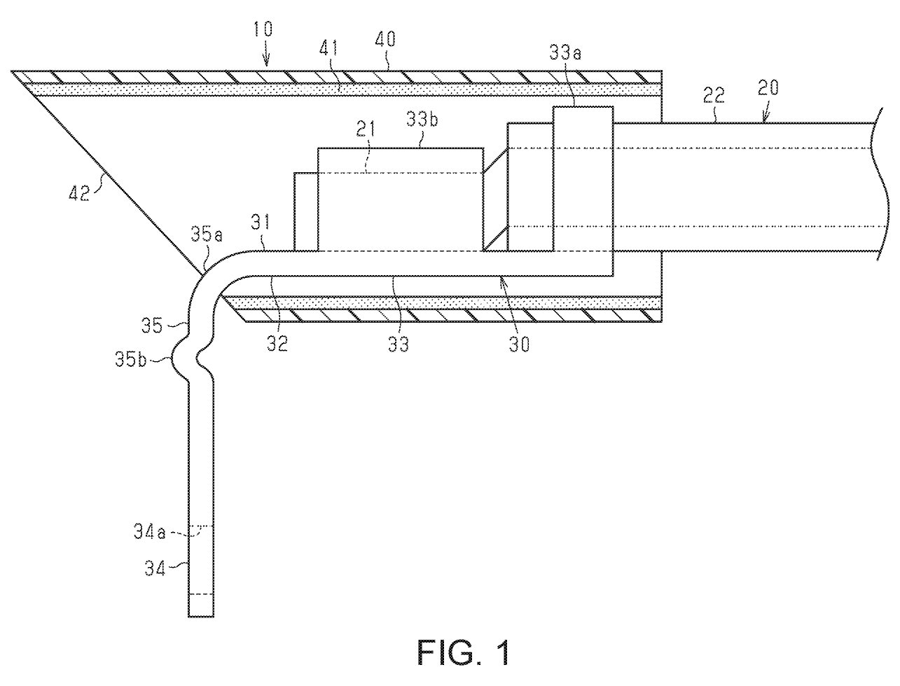

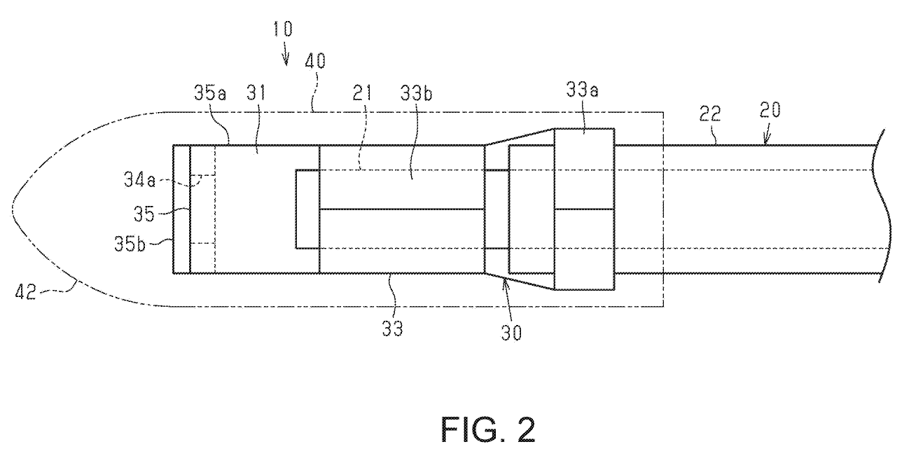

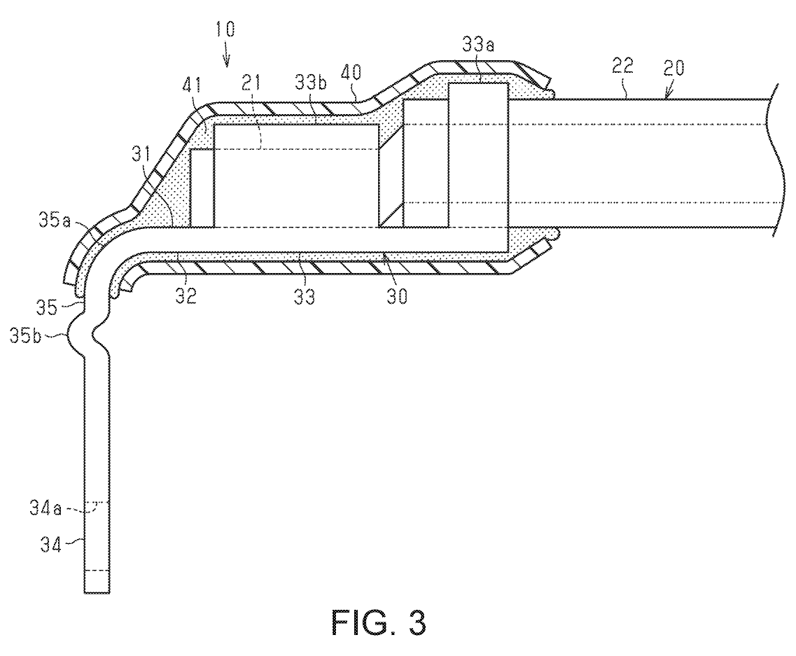

As shown in FIGS. 1 to 3, a terminated wire 10 includes an electric wire 20, a terminal 30, and a shrinkable tube 40. Note that FIGS. 1 and 2 show the terminated wire 10 in the process of being manufactured, and FIG. 3 shows the completely manufactured terminated wire 10.

### Configuration of Electric Wire 20

The electric wire 20 has a conductive core wire 21 and an insulating coating 22 that covers the core wire 21.

The core wire 21 may be, for example, a stranded wire formed by twisting together a plurality of metal wires, a columnar conductor made of a single columnar metal rod having a solid structure, or the like. The constituent material of the core wire 21 may be, for example, a metal material such as a copper-based material or aluminum-based material.

The insulating coating 22 covers, for example, an outer surface of the core wire 21 over the entire circumference in the circumferential direction. The insulating coating 22 is made of, for example, an insulating material such as a synthetic resin. The constituent material of the insulating coating 22 may be, for example, a synthetic resin containing as a main component a polyolefin-based resin, such as cross-linked polyethylene or cross-linked polypropylene. A longitudinal end of the core wire 21 is exposed from the insulating coating 22.

### Configuration of Terminal 30

The terminal 30 has a core wire connection section 33 to which the core wire 21 disposed on the first main surface 31 is connected, a counterpart connection section 34 that is to be connected to a counterpart member (not shown), and a terminal intermediate section 35 that connects the core wire connection section 33 and the counterpart connection section 34.

The terminal 30 is connected to the core wire 21 exposed from the insulating coating 22. The terminal 30 has a plate shape having a first main surface 31 and a second main surface 32 on the side opposite to the first main surface 31. In other words, the terminal 30 is formed by processing a metal plate material. The constituent material of the terminal 30 may be, for example, a metal material such as a copper-based or aluminum-based material.

The core wire connection section 33 in this embodiment has a cover-crimp portion 33a and a core wire crimp portion 33b. The cover-crimp portion 33a is crimped so as to hold the insulating coating 22 therein while surrounding the insulating coating 22. The core wire crimp portion 33b is crimped so as to hold the core wire 21 therein while surrounding the core wire 21. This electrically and mechanically connects the core wire connection section 33 to the core wire 21.

The counterpart connection section 34 has a connection hole 34a. For example, the counterpart connection section 34 is fastened to a counterpart member (not shown) with a bolt (not shown) passing through the connection hole 34a, and is electrically connected to the counterpart member.

The terminal intermediate section 35 has a bent portion 35a (bend) that is bent such that the first main surface 31 faces outward. In the present embodiment, the terminal intermediate section 35 is bent 90° at the bent portion 35a. When the terminal 30 is viewed from the side (see FIGS. 1 and 3), the bent portion 35a is bent in a curved shape. In other words, the bent portion 35a is curved.

The terminal intermediate section 35 has a protrusion 35b serving as a suppression portion at a position closer to the counterpart connection section 34 than the bent portion 35a. The protrusion 35b is formed so as to project from the first main surface 31. More specifically, the protrusion 35b is formed by applying pressure to a portion of the second main surface 32 such that a portion of the first main surface 31 protrudes.

### Configuration of Shrinkable Tube 40

The shrinkable tube 40 has a tubular shape, and an adhesive 41 is disposed on the inner surface thereof. The shrinkable tube 40 covers a portion of the electric wire 20 and a portion of the terminal 30. Specifically, the shrinkable tube 40 is, for example, a heat-shrinkable tube that shrinks when heated. Examples of the constituent material of the shrinkable tube 40 include a polyolefin resin, a fluorine-based polymer, and a thermoplastic elastomer. Examples of the constituent material of the adhesive 41 include a hot-melt adhesive that melts when heated and hardens when cooled.

Before being heated and shrunk, the shrinkable tube 40 has a cylindrical shape as shown in FIG. 1. The adhesive 41 is disposed on the inner surface of the shrinkable tube 40 with a uniform thickness. Also, before being heated and shrunk, the shrinkable tube 40 has a first end 42 that is obliquely cut relative to the axis of the shrinkable tube 40.

As shown in FIG. 3, after being heated and shrunk, the shrinkable tube 40 extends over the core wire connection section 33, the core wire 21, and the terminal intermediate section 35. The shrinkable tube 40 in the present embodiment is disposed to cover an area from an end of the insulating coating 22, including the cover-crimp portion 33a, to an intermediate portion of the terminal intermediate section 35.

The shrinkable tube 40 before being shrunk is obliquely cut, and thereby covers the first main surface 31 of the terminal intermediate section 35 over a longer length than the second main surface 32 of the terminal intermediate section 35.

Further, the shrinkable tube 40 in the present embodiment covers the first main surface 31 at the bent portion 35a. In this state, the adhesive 41 is disposed so as to fill a gap inside the shrinkable tube 40. Furthermore, the protrusion 35b is located at a portion that is not covered by the shrinkable tube 40 but exposed from the shrinkable tube 40, and functions to suppress the flow of a melted adhesive 41 toward the counterpart connection section 34 along the first main surface 31.

### Method for Manufacturing Terminated Wire 10

Next, a method for manufacturing the terminated wire 10 and the operation thereof will be described.

The method for manufacturing the terminated wire 10 configured as described above includes a cutting step, a disposing step, and a shrinking step.

First, in the cutting step, a long tubular shrinkable tube 40 before being shrunk, with the adhesive 41 disposed on its inner surface, is cut to obtain the shrinkable tube 40 in which the first end 42 is obliquely cut (see FIG. 1).

Next, in the disposing step, the shrinkable tube 40 before being shrunk is disposed on the outer side of the terminal 30 such that the longer portion of the first end 42 of the shrinkable tube 40 faces the first main surface 31, as shown in FIG. 1.

Next, in the shrinking step, the shrinkable tube 40 is heated and is thereby shrunk from the state shown in FIG. 1 to the state shown in FIG. 3. At this time, the adhesive 41 temporarily melts and fills the gap inside the shrinkable tube 40. The manufacture of the terminated wire 10 is thus completed.

With the thus-configured terminated wire 10, the shrinkable tube 40 and the adhesive 41 prevent the core wire connection section 33 and the core wire 21 from being exposed to water. Accordingly, for example, corrosion is suppressed in the area where the core wire connection section 33 and the core wire 21 are connected.

### Effects of the Present Embodiment

Next, effects of the above embodiment will be described.

(1) The shrinkable tube 40 extends over the core wire connection section 33, the core wire 21, and the terminal intermediate section 35, and covers the first main surface 31 of the terminal intermediate section 35 over a longer length than the second main surface 32 of the terminal intermediate section 35. This can enhance water sealing performance along the first main surface 31. Specifically, the first main surface 31, on which the core wire 21 is disposed, tends to have lower water sealing performance than the second main surface 32, due in part to the formation of a step on the first main surface 31 that causes the adhesive 41 to accumulate locally in larger amounts. The first main surface 31, which thus tends to have lower water sealing performance, is covered by the shrinkable tube 40 over a longer length than the second main surface 32, and a larger amount of adhesive 41 is disposed for the longer covered portion. The water sealing performance can thereby be enhanced. Accordingly, the water sealing performance along both the first and second main surfaces 31 and 32 can be enhanced sufficiently.

(2) The terminal intermediate section 35 has a bent portion 35a that is bent such that the first main surface 31 faces outward, and the shrinkable tube 40 covers the first main surface 31 at the bent portion 35a. This can particularly enhance the water sealing performance of the first main surface 31, whose water sealing performance tends to be low.

(3) The terminal intermediate section 35 has the protrusion 35b serving as a suppression portion that suppresses the flow of the adhesive 41 toward the counterpart connection section 34 along the first main surface 31, in the area exposed from the shrinkable tube 40. The adhesive 41 is thereby prevented from reaching the counterpart connection section 34. Since the first main surface 31 is covered by the shrinkable tube 40 over a longer length than the second main surface 32, a greater amount of adhesive 41 is disposed on the first main surface 31. Thus, a larger amount of melted adhesive 41 may flow toward the counterpart connection section 34, but this adhesive 41 is prevented from reaching the counterpart connection section 34.

(4) The suppression portion is the protrusion 35b projecting from the first main surface 31, and accordingly, can be readily provided on a plate-shaped terminal 30.

(5) The method for manufacturing the terminated wire 10 includes: a disposing step of disposing the shrinkable tube 40 before being shrunk, in which the first end 42 is obliquely cut, such that the longer portion of the first end 42 faces the first main surface 31; and a shrinking step of shrinking the shrinkable tube 40. This allows the shrinkable tube 40 to cover the first main surface 31 of the terminal intermediate section 35 over a longer length than the second main surface 32 of the terminal intermediate section 35, using a simple method.

### Modifications

The above embodiment can be modified for implementation as follows. The above embodiment and the following modifications can be implemented in combination with each other as long as no technical contradiction arises.

The terminal intermediate section 35 in the above embodiment has a bent portion 35a that is bent such that the first main surface 31 faces outward, but is not limited to this configuration. The terminal intermediate section 35 may alternatively be configured without the bent portion 35a. Also, the terminal intermediate section 35 in the above embodiment is bent 90° by the bent portion 35a, but is not limited to this configuration. The terminal intermediate section 35 may alternatively be bent at an angle less than 90° or at an angle greater than 90°.

The shrinkable tube 40 in the above embodiment covers the first main surface 31 at the bent portion 35a, but is not limited to this configuration. The shrinkable tube 40 may alternatively be configured to not cover the bent portion 35a.

The terminal intermediate section 35 in the above embodiment has the protrusion 35b serving as a suppression portion that suppresses the flow of the adhesive 41 toward the counterpart connection section 34 along the first main surface 31, but is not limited to this configuration. The terminal intermediate section 35 may alternatively be configured without the protrusion 35b.

The suppression portion in the above embodiment is a protrusion 35b projecting from the first main surface 31. However, the suppression portion may have another configuration as long as it can suppress the flow of the adhesive 41 toward the counterpart connection section 34 along the first main surface 31.

The core wire connection section 33 in the above embodiment has the cover-crimp portion 33a and the core wire crimp portion 33b. However, the core wire connection section 33 may have another configuration as long as the core wire 21 disposed on the first main surface 31 is connected to the core wire connection section 33.

The method for manufacturing the terminated wire 10 in the above embodiment may be changed to another manufacturing method as long as the same terminated wire 10 can be manufactured.

The modes for implementation disclosed herein are illustrative in all respects, and the present disclosure is not limited to these examples. That is, the scope of the present disclosure is indicated by the claims, and is intended to encompass all modifications equivalent in meaning and scope to the claims.

What is claimed is:

1. A terminated wire comprising:
a core wire;
an insulating coating that covers the core wire;
a terminal that is connected to the core wire exposed from the insulating coating; and
a shrinkable tube that covers a portion of the core wire and a portion of the terminal and that has an adhesive disposed on an inner surface of the shrinkable tube, wherein:
the terminal is formed in a plate shape having a first main surface and a second main surface, and the terminal has:
a core wire connection section to which the core wire disposed on the first main surface is connected;
a counterpart connection section that is to be connected to a counterpart member; and
a terminal intermediate section connecting the core wire connection section and the counterpart connection section, and
the shrinkable tube extends over the core wire connection section, the core wire, and the terminal intermediate section, and covers the first main surface at the terminal intermediate section over a longer length than the second main surface at the terminal intermediate section.

2. The terminated wire according to claim 1, wherein:
the terminal intermediate section has a bend that is bent such that the first main surface faces outward, and
the shrinkable tube covers the first main surface at the bend.

3. The terminated wire according to claim 1,
wherein the terminal intermediate section has, in an area thereof exposed from the shrinkable tube, a suppression portion configured to suppress a flow of the adhesive toward the counterpart connection section along the first main surface.

4. The terminated wire according to claim 3,
wherein the suppression portion is a protrusion projecting from the first main surface.

5. A method for manufacturing the terminated wire according to claim 1, the method comprising:
disposing the shrinkable tube before being shrunk on an outer side of the terminal, the shrinkable tube having the adhesive disposed on the inner surface thereof and having an obliquely cut first end, such that a longer portion of the first end faces the first main surface; and
shrinking the shrinkable tube after disposing the shrinkable tube.
